(19) United States
(12) Patent Application Publication
(10) Pub. No.: US 2024/0365391 A1
(43) Pub. Date: Oct. 31, 2024

(54) RETRANSMISSIONS ASSOCIATED WITH A PHYSICAL DOWNLINK CONTROL CHANNEL ORDERED RANDOM ACCESS CHANNEL PROCEDURE

(71) Applicant: QUALCOMM Incorporated, San Diego, CA (US)

(72) Inventors: Tianyang BAI, Mountain View, CA (US); Jelena DAMNJANOVIC, Del Mar, CA (US); Yan ZHOU, San Diego, CA (US)

(21) Appl. No.: 18/643,357

(22) Filed: Apr. 23, 2024

Related U.S. Application Data
(60) Provisional application No. 63/498,938, filed on Apr. 28, 2023.

(51) Int. Cl. H04W 74/0833; H04W 72/232

(52) U.S. Cl. CPC H04W 74/0833; H04W 72/232

(57) ABSTRACT

Various aspects of the present disclosure generally relate to wireless communication. In some aspects, a user equipment (UE) may receive a physical downlink control channel (PDCCH) order that indicates to perform a random access channel (RACH) procedure that is associated with a candidate cell and is not associated with a configured random access response (RAR), the PDCCH order indicating a retransmission state associated with a physical random access channel (PRACH) message that is associated with the candidate cell. The UE may transmit the PRACH message that is associated with the candidate cell based at least in part on the retransmission state. Numerous other aspects are described.

### CROSS-REFERENCE TO RELATED APPLICATION

This patent application claims priority to U.S. Patent Application No. 63/498,938, filed on Apr. 28, 2023, entitled “RETRANSMISSIONS ASSOCIATED WITH A PHYSICAL DOWNLINK CONTROL CHANNEL ORDERED RANDOM ACCESS CHANNEL PROCEDURE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for retransmissions associated with a physical downlink control channel (PDCCH) ordered random access channel (RACH) procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a physical downlink control channel (PDCCH) order that indicates to perform a random access channel (RACH) procedure that is associated with a candidate cell and is not associated with a configured random access response (RAR), the PDCCH order indicating a retransmission state associated with a physical random access channel (PRACH) message that is associated with the candidate cell. The method may include transmitting the PRACH message that is associated with the candidate cell based at least in part on the retransmission state.

Some aspects described herein relate to a method of wireless communication performed by a network node. The method may include transmitting a PDCCH order associated with performing a RACH procedure that is associated with a candidate cell and is not associated with a configured RAR, the PDCCH order indicating a retransmission state associated with a PRACH message that is associated with the candidate cell.

Some aspects described herein relate to an apparatus for wireless communication at a UE. The apparatus may include a memory and one or more processors coupled to the memory. The one or more processors may be configured individually or in any combination, to receive a PDCCH order that indicates to perform a RACH procedure that is associated with a candidate cell and is not associated with a configured RAR, the PDCCH order indicating a retransmission state associated with a PRACH message that is associated with the candidate cell. The one or more processors may be configured to transmit the PRACH message that is associated with the candidate cell based at least in part on the retransmission state.

Some aspects described herein relate to an apparatus for wireless communication at a network node. The apparatus may include a memory and one or more processors coupled to the memory. The one or more processors may be configured individually or in any combination, to transmit a PDCCH order associated with performing a RACH procedure that is associated with a candidate cell and is not associated with a configured RAR, the PDCCH order indicating a retransmission state associated with a PRACH message that is associated with the candidate cell.

Some aspects described herein relate to a non-transitory computer-readable medium that stores a set of instructions for wireless communication by a UE. The set of instructions, when executed by one or more processors of the UE, may cause the UE to receive a PDCCH order that indicates to perform a RACH procedure that is associated with a candidate cell and is not associated with a configured RAR, the PDCCH order indicating a retransmission state associated with a PRACH message that is associated with the candidate cell. The set of instructions, when executed by one or more processors of the UE, may cause the UE to transmit the PRACH message that is associated with the candidate cell based at least in part on the retransmission state.

Some aspects described herein relate to a non-transitory computer-readable medium that stores a set of instructions for wireless communication by a network node. The set of instructions, when executed by one or more processors of the network node, may cause the network node to transmit a PDCCH order associated with performing a RACH procedure that is associated with a candidate cell and is not associated with a configured RAR, the PDCCH order indicating a retransmission state associated with a PRACH message that is associated with the candidate cell.

Some aspects described herein relate to an apparatus for wireless communication. The apparatus may include means for receiving a PDCCH order that indicates to perform a RACH procedure that is associated with a candidate cell and is not associated with a configured RAR, the PDCCH order indicating a retransmission state associated with a PRACH message that is associated with the candidate cell. The apparatus may include means for transmitting the PRACH message that is associated with the candidate cell based at least in part on the retransmission state.

Some aspects described herein relate to an apparatus for wireless communication. The apparatus may include means for transmitting a PDCCH order associated with performing a RACH procedure that is associated with a candidate cell and is not associated with a configured RAR, the PDCCH order indicating a retransmission state associated with a PRACH message that is associated with the candidate cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIGS. 5A and 5B are diagrams illustrating a first example and a second example, respectively, of a physical downlink control channel (PDCCH) order that is associated with triggering a random access channel (RACH) procedure, in accordance with the present disclosure.

FIG. 6 is a diagram illustrating an example of a wireless communication process between a first network node, a UE, and a second network node, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In some aspects, a network node may transmit a physical downlink control channel (PDCCH) order to instruct a user equipment (UE) to initiate a random access channel (RACH) procedure. In some aspects, the PDCCH order may be associated with a candidate network node and may not be associated with a configured random access response (RAR). A PDCCH order that is associated with a candidate network node and is not associated with a configured RAR may result in ambiguity at the UE, such as ambiguity on how a UE performs physical random access channel (PRACH) retransmissions that are associated with the candidate network node.

To illustrate, the UE may not receive an RAR from the candidate network node that confirms receipt of the PRACH, and a first ambiguity may be associated with whether the UE automatically transmits a PRACH retransmission or waits for an instruction to transmit the PRACH retransmission. In some aspects, the UE may autonomously transmit PRACH retransmissions and incrementally increase a transmission power level of each subsequent PRACH retransmission. However, the automatic transmission of PRACH retransmissions may needlessly consume UE resources and/or air interface resources, such as in a scenario associated with the candidate network node successfully receiving a PRACH transmission and/or a PRACH retransmission without transmitting an RAR. Accordingly, the continued and autonomous PRACH retransmissions may needlessly consume the UE resources and/or air interface resources, resulting in a shorter battery life at the UE, delayed computations by the UE for other applications, decreased data throughput in a wireless network, and/or increased data transfer latencies in the wireless network.

As another example of ambiguity, the UE may refrain from autonomously transmitting PRACH retransmissions, and instead wait to receive an instruction to transmit a PRACH and/or a PRACH retransmission, such as a PDCCH order. However, the PDCCH order may lack information that indicates whether the PDCCH order is associated with an initial PRACH transmission or a PRACH retransmission.

Accordingly, a second ambiguity may be associated with what transmission power level the UE should use for transmitting the PRACH. Without knowledge on whether a PDCCH order is associated with an initial PRACH transmission or a PRACH retransmission, the UE may transmit the PRACH and/or PRACH retransmission using a transmission power level that results in a candidate network node failing to receive the PRACH and/or may transmit additional PRACH (re)transmissions that needlessly consume UE resources (e.g., battery power and/or computing resources) and/or air interface resources. The needless consumption of UE resources and/or air interface resources may result in a shorter battery life at the UE, delayed computations by the UE for other applications, decreased data throughput in a wireless network, and/or increased data transfer latencies in the wireless network.

Various aspects relate generally to retransmissions for a PDCCH ordered RACH procedure. Some aspects more specifically relate to resolving PRACH transmission ambiguities at the UE. In some aspects, a UE may receive a PDCCH order that instructs the UE to perform a RACH procedure that is associated with a candidate cell and is not associated with a configured RAR. Alternatively, or additionally, the PDCCH order may indicate a retransmission state associated with a PRACH that is associated with the candidate cell. Accordingly, the UE may transmit a PRACH that is associated with the candidate cell based at least in part on the retransmission state.

A PDCCH order that indicates a retransmission state associated with a PRACH directed to a candidate cell may preserve UE resources and/or air interface resources of a wireless network. To illustrate, the indication of a retransmission state for a PRACH transmission may resolve a transmission power level ambiguity at the UE, and may enable the UE to transmit a PRACH and/or PRACH retransmission using fewer transmissions. Fewer transmissions by the UE may reduce a consumption of UE resources and extend a battery life of the UE. Fewer transmissions by the UE may also preserve UE computing resources for other purposes and increase a responsiveness of the UE. Alternatively, or additionally, fewer transmissions by the UE may reduce a consumption of air interface resources by the UE and preserve the air interface resources for use by other devices. Preserving the air interface resources for use by other devices may increase data throughput and/or reduce data transfer latencies within a wireless network.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

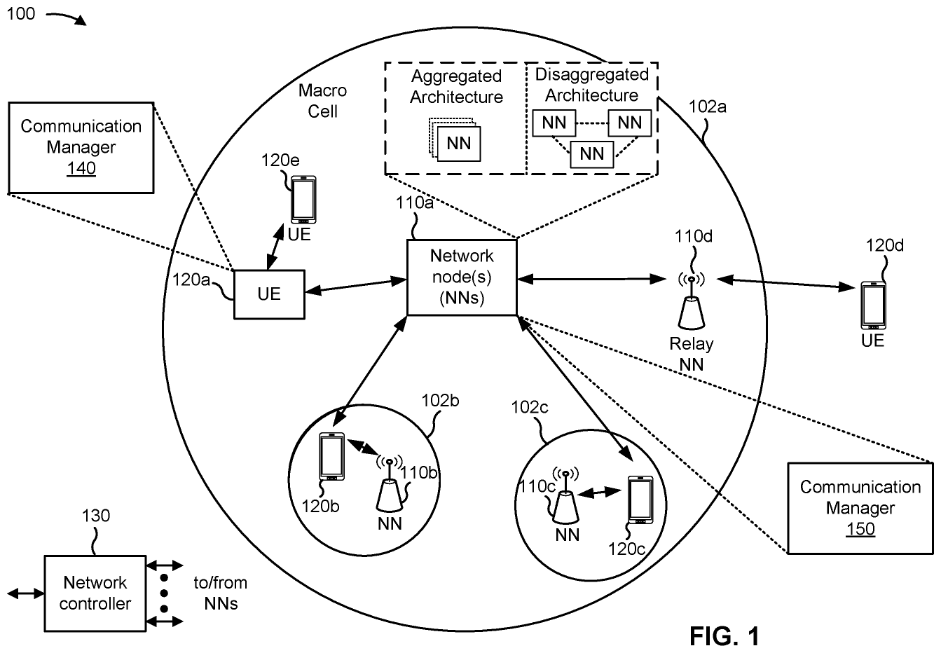

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmission power levels, different coverage areas, and/or different impacts on interference in the wireless network 100. For example, macro network nodes may have a high transmission power level (e.g., 5 to 40 watts) whereas pico network nodes, femto network nodes, and relay network nodes may have lower transmission power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a PDCCH order that indicates to perform a RACH procedure that is associated with a candidate cell and is not associated with a configured RAR, the PDCCH order indicating a retransmission state associated with a PRACH message that is associated with the candidate cell; and transmit the PRACH message that is associated with the candidate cell based at least in part on the retransmission state. Additionally, or alternatively, the communication manager 140 may perform one or more other operations described herein.

In some aspects, a network node (e.g. a network node 110) may include a communication manager 150. As described in more detail elsewhere herein, the communication manager 150 may transmit a PDCCH order associated with performing a RACH procedure that is associated with a candidate cell and is not associated with a configured RAR, the PDCCH order indicating a retransmission state associated with a PRACH message that is associated with the candidate cell. Additionally, or alternatively, the communication manager 150 may perform one or more other operations described herein.

As indicated above, FIG. 1 is provided as an example. Other examples may differ from what is described with regard to FIG. 1.

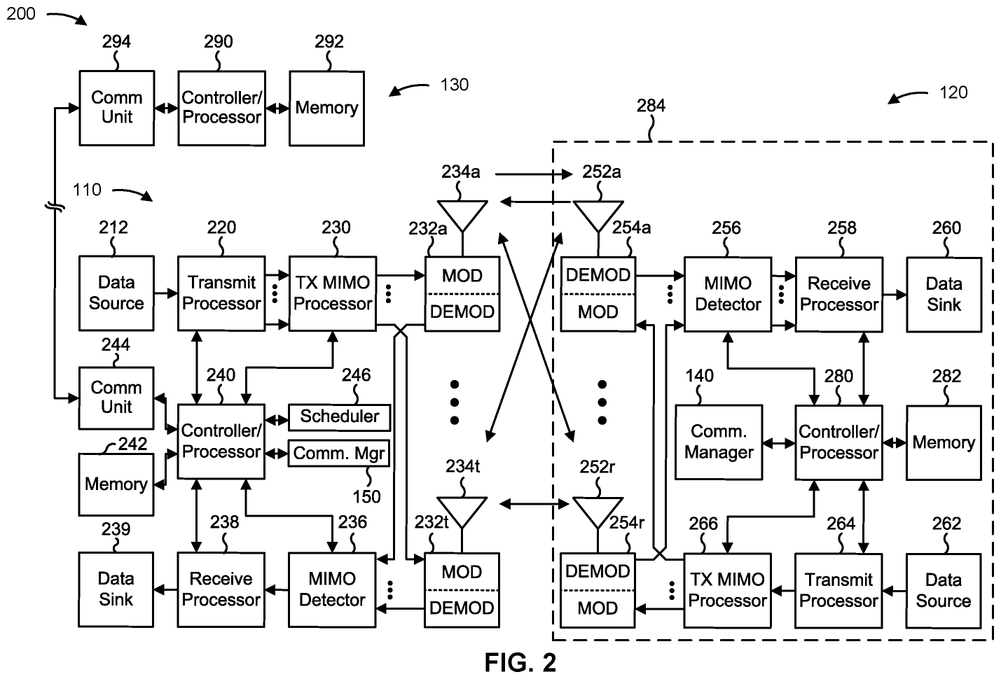

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

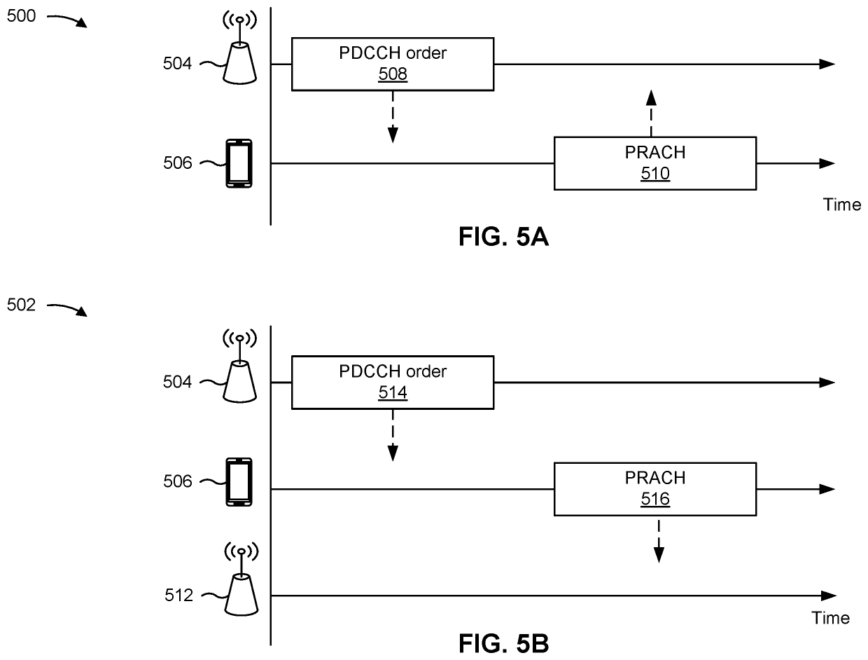

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

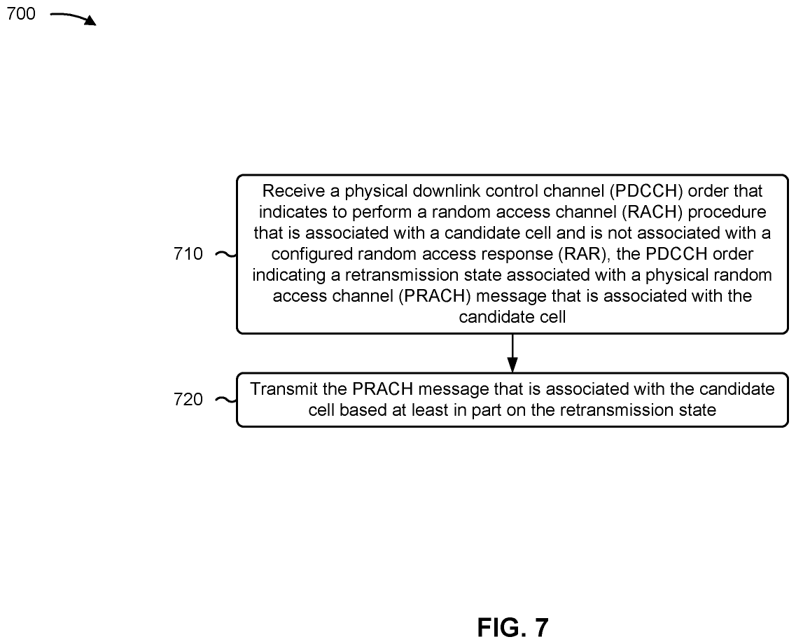

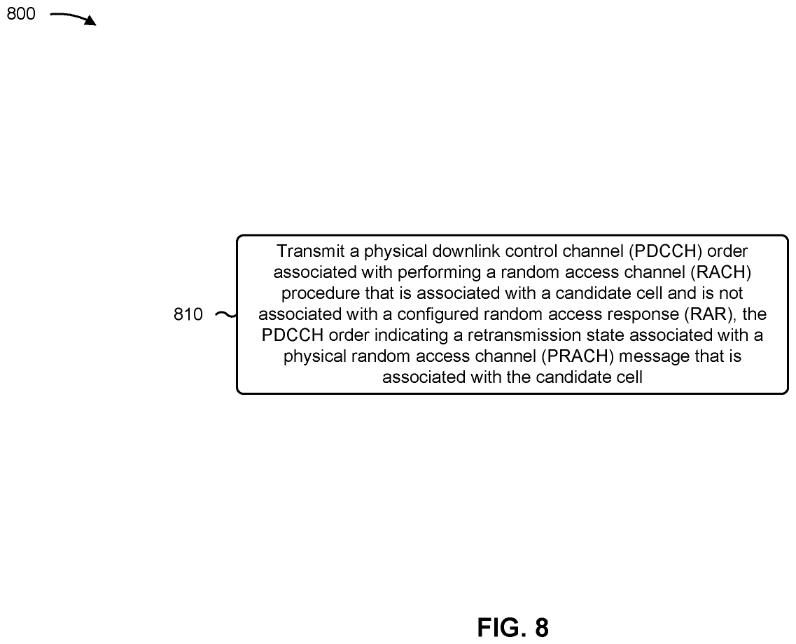

The controller/processor 240 of the network node 110, the controller/processor 280 of the UE 120, and/or any other component(s) of FIG. 2 may perform one or more techniques associated with a PDCCH ordered RACH, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a PDCCH order that indicates to perform a RACH procedure that is associated with a candidate cell and is not associated with a configured RAR, the PDCCH order indicating a retransmission state associated with a PRACH message that is associated with the candidate cell; and/or means for transmitting the PRACH message that is associated with the candidate cell based at least in part on the retransmission state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for transmitting a PDCCH order associated with performing a RACH procedure that is associated with a candidate cell and is not associated with a configured RAR, the PDCCH order indicating a retransmission state associated with a PRACH message that is associated with the candidate cell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

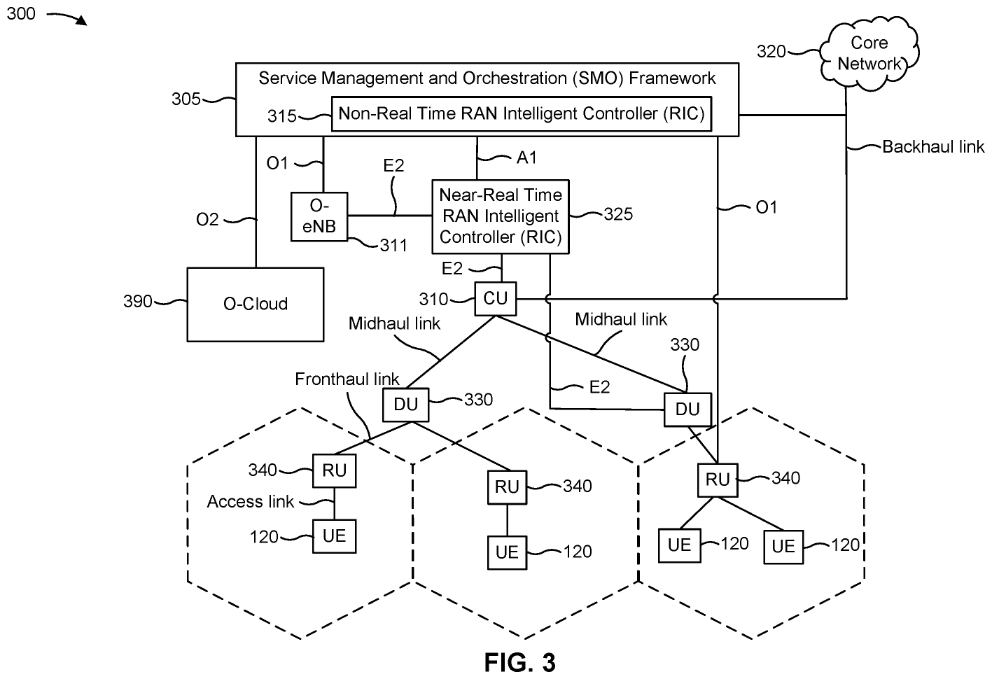

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface).

For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325.

The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

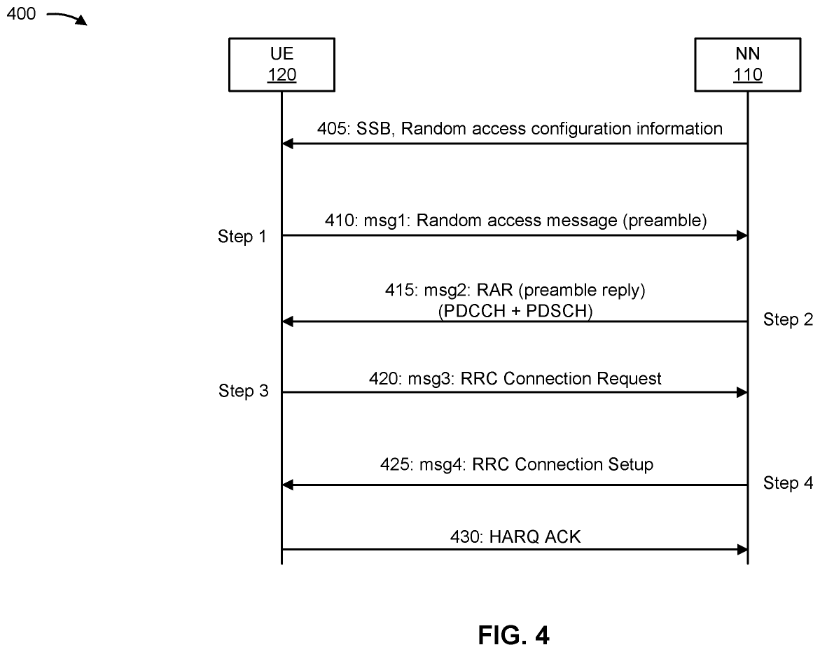

FIG. 4 is a diagram illustrating an example 400 of a four-step random access procedure, in accordance with the present disclosure. As shown in FIG. 4, a network node 110 and a UE 120 may communicate with one another to perform the four-step random access procedure. While the example 400 is a four-step random access procedure, other examples may include a two-step random access procedure that consolidates one or more messages shown by FIG. 4.

As shown by reference number 405, the network node 110 may transmit, and the UE 120 may receive, at least one synchronization signal block (SSB) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a PDCCH order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3). As described above, in some aspects, the random access configuration information may include one or more parameters for receiving an RAR (e.g., a configured RAR).

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

FIGS. 5A and 5B are diagrams illustrating a first example 500 and a second example 502, respectively, of a PDCCH order that is associated with triggering a RACH procedure (e.g., a PDCCH ordered RACH procedure), in accordance with the present disclosure.

In some aspects, a network node (e.g., a network node 110) may transmit a PDCCH order to instruct a UE (e.g., 120) to initiate a RACH procedure, such as the four-step RACH procedure described with regard to FIG. 4 and/or a two-step RACH procedure. As one example, the network node may transmit the PDCCH order in downlink control information (DCI) based at least in part on using a DCI format that is specific to and/or associated with the PDCCH order. That is, the DCI format may partition the DCI into one or more fields that are specific to the PDCCH order. The network node may transmit the PDCCH order based at least in part on a variety of trigger events, such as a trigger event associated with the network node detecting that the UE's timing is out-of-sync with the network node's timing. In some aspects, the network node may transmit a PDCCH order that is associated with another network node, such as a candidate network node, as described below.

The first example 500 shown by FIG. 5A includes a communication exchange between a network node 504 (e.g., a network node 110) and a UE 506 (e.g., a UE 120). A horizontal axis in the first example 500 represents time. As described above, the network node 504 may transmit a PDCCH order 508 that instructs the UE 506 to initiate a RACH procedure. In some aspects, the network node 504 may transmit the PDCCH order in DCI based at least in part on using a DCI format specific to the PDCCH order. Alternatively, or additionally, the network node 504 may indicate random access configuration information that is associated with the RACH procedure, such as by transmitting the random access configuration information in an SIB prior to transmitting the PDCCH order 508, in an RRC message prior to transmitting the PDCCH order 508, and/or in the PDCCH order 508. While the random access configuration information may include one or more parameters for receiving an RAR (e.g., a configured RAR), other examples may include the random access configuration information omitting the parameter(s) associated with receiving the RAR. That is, the RAR may not be configured and/or may be a non-configured RAR. As shown by FIG. 5A, the UE 506 may respond to the PDCCH order 508 based at least in part on transmitting a PRACH 510 to the network node 504.

The second example 502 shown by FIG. 5B includes a communication exchange between the network node 504, the UE 506, and a second network node 512. In some aspects, the network node 504 may act as a primary cell of a master cell group or a secondary cell group (e.g., a special cell (spCell)) that provides service to the UE 506. A horizontal axis in the second example 502 represents time.

In some aspects, the network node 504 may transmit a PDCCH order 514 that instructs the UE 506 to initiate a RACH procedure (e.g., a PDCCH ordered RACH procedure) that is associated with the second network node 512. To illustrate, the second network node 512 may be a candidate network node and/or candidate cell for inclusion in the master cell group, inclusion in the secondary cell group, and/or for a UE handover (e.g., the UE 604). Accordingly, and based at least in part on acting as an spCell, the network node 504 may transmit the PDCCH order 514 to instruct the UE 506 to perform a RACH procedure with the second network node 512 and/or to acquire timing synchronization with the second network node 512. As shown by FIG. 5B, the UE 506 may transmit a PRACH 516 to the second network node 512 as part of performing the PDCCH ordered RACH procedure. In some aspects, a PDCCH order that is associated with a candidate network node may not be associated with a configured RAR. Based at least in part on the RAR not being configured, the UE 506 may instead obtain timing advance (TA) information associated with the second network node 512 in a cell switch command (e.g., instead of an RAR).

A PDCCH order that is associated with a candidate network node and is not associated with a configured RAR may result in ambiguity on how a UE performs PRACH retransmissions. To illustrate, for such a PDCCH order, the UE may not receive an RAR from the candidate network node that confirms receipt of the PRACH. Accordingly, a first ambiguity may be associated with whether the UE automatically transmits a PRACH retransmission or waits for an instruction to transmit the PRACH retransmission. In some aspects, the UE may automatically transmit PRACH retransmissions without receiving confirmation that the candidate network node has received one or more of the PRACH retransmissions. Alternatively, or additionally, the UE may incrementally increase a transmission power level of each subsequent PRACH retransmission. However, the UE may needlessly consume UE resources (e.g., battery power and/or computing resources) and/or air interface resources that could be used for other purposes. To illustrate, in at least one scenario, the candidate network node may successful receive an initial PRACH transmission and/or a subsequent PRACH retransmission, but the UE continues to autonomously transmit PRACH retransmissions based at least in part on not receiving an RAR. Accordingly, the continued and autonomous PRACH retransmissions may needlessly consume the UE resources and/or air interface resources, resulting in a shorter battery life at the UE, delayed computations by the UE for other applications, decreased data throughput in a wireless network, and/or increased data transfer latencies in the wireless network.

Alternatively, or additionally, the UE may refrain from autonomously transmitting PRACH retransmissions and/or wait to receive an instruction to transmit a PRACH and/or a PRACH retransmission. As one example, the UE may wait to receive a PDCCH order that instructs the UE to perform a RACH procedure. However, the PDCCH order may lack information that indicates whether the PDCCH order is associated with an initial PRACH transmission or a PRACH retransmission. Accordingly, a second ambiguity may be associated with what transmission power level the UE should use for transmitting the PRACH (e.g., an initial transmission power level for an initial PRACH and/or an increased transmission power level for a PRACH retransmission). Without knowledge on whether a PDCCH order is associated with an initial PRACH transmission or a PRACH retransmission, the UE may use a transmission power level for transmitting a PRACH (and/or PRACH retransmission) that results in a candidate network node failing to receive the PRACH and/or the UE transmitting additional PRACH (re)transmissions that could have been mitigated with an appropriate transmission power level. The additional PRACH retransmissions may consume UE resources (e.g., battery power and/or computing resources) and/or air interface resources that could be used for other purposes and, as described above, may result in a shorter battery life at the UE, delayed computations by the UE for other applications, decreased data throughput in a wireless network, and/or increased data transfer latencies in the wireless network.

Some techniques and apparatuses described herein provide retransmissions for a PDCCH ordered RACH procedure. In some aspects, a UE may receive a PDCCH order that instructs the UE to perform a RACH procedure that is associated with a candidate cell and is not associated with a configured RAR. As described below, the PDCCH order may indicate a retransmission state associated with a PRACH that is associated with the candidate cell. The retransmission state, for instance, may be an enabled retransmission state that indicates that the PRACH is a retransmission to the candidate cell. Alternatively, or additionally, the retransmission state may be a disabled retransmission state that indicates that the PRACH is not a retransmission. Accordingly, the UE may transmit a PRACH that is associated with the candidate cell based at least in part on the retransmission state.

In some aspects, the UE may autonomously retransmit one or more PRACH retransmissions and without receiving a second PDCCH order. The UE may retransmit the PRACH retransmission(s) based at least in part on a maximum number of allowed PRACH transmissions. The UE may receive, prior to transmitting the maximum number of allowed retransmissions, an instruction to cease transmitting the PRACH retransmissions.

A network node transmitting, and a UE receiving, a PDCCH order that indicates a retransmission state associated with a PRACH directed to a candidate cell may preserve UE resources (e.g., battery power, memory, and/or processor resources) and/or air interface resources of a wireless network. For example, as described above, the PDCCH order may be associated with a non-configured RAR, and the UE may not receive an RAR from the candidate cell. The PDCCH order indicating a retransmission state may resolve a transmission power level ambiguity at the UE, and enable the UE to use a transmission power level for transmitting a PRACH that results in a candidate network node receiving the PRACH and/or additional PRACH (re)transmissions with fewer transmissions by the UE. In some aspects, the UE may autonomously transmit PRACH retransmission(s), and the network node may instruct the UE to cease transmitting the PRACH retransmission(s), which may also result in fewer transmissions by the UE.

Fewer transmissions by the UE may reduce a consumption of UE resources and extend a battery life of the UE. Fewer transmissions by the UE may also preserve UE computing resources for other purposes and increase a responsiveness of the UE. Alternatively, or additionally, fewer transmissions by the UE may reduce a consumption of air interface resources by the UE and preserve the air interface resources for use by other devices. Preserving the air interface resources for use by other devices may increase data throughput and/or reduce data transfer latencies within a wireless network.

As indicated above, FIGS. 5A and 5B are provided as examples. Other examples may differ from what is described with regard to FIGS. 5A and 5B.

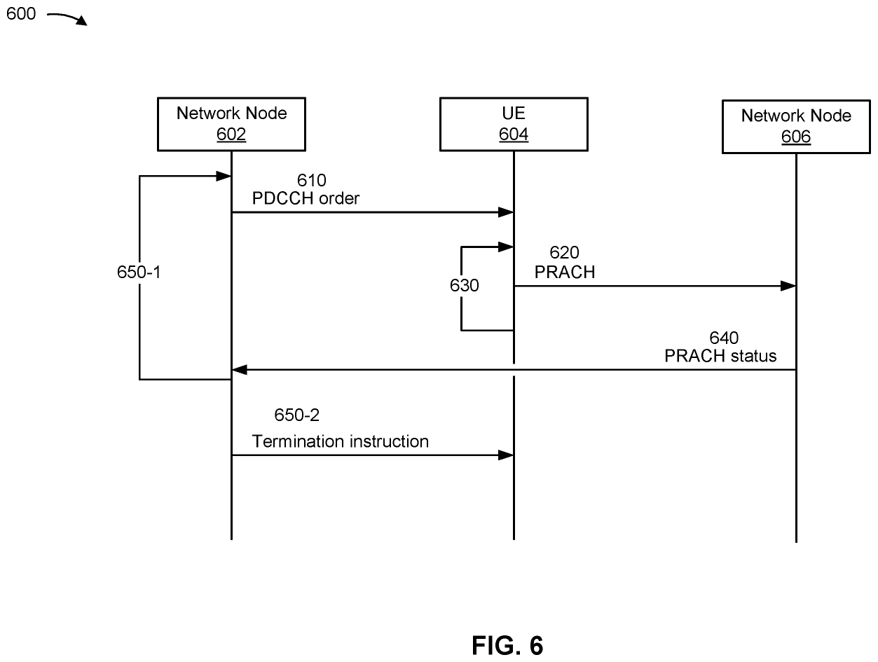

FIG. 6 is a diagram illustrating an example 600 of a wireless communication process between a first network node 602 (e.g., a network node 110), a UE 604 (e.g., a UE 120), and a second network node 606 (e.g., another network node 110), in accordance with the present disclosure.

As shown by reference number 610, a first network node 602 may transmit, and a UE 604 may receive, a PDCCH order that indicates to perform a RACH procedure that is associated with a candidate cell and/or a candidate network node and is not associated with a configured RAR. In some aspects, the PDCCH order may indicate a retransmission state (e.g., an enabled retransmission state and/or a disabled retransmission state) for a PRACH that is associated with the candidate cell. To illustrate, an enabled retransmission state may indicate that a PRACH associated with the PDCCH order is a PRACH retransmission to the candidate cell, and a disabled retransmission state may indicate that the PRACH associated with the PDCCH order is not a PRACH retransmission (e.g., the PRACH is an initial and/or first PRACH transmission to the candidate cell).

In some aspects, the first network node 602 may transmit the PDCCH order in DCI and/or based at least in part on using a PDCCH order DCI format. The PDCCH order DCI format may partition the DCI and/or the PDCCH order into one or more fields, and at least some of the fields may be specific to a PDCCH order. In transmitting the PDCCH order, the first network node 602 may configure each field with respective values to indicate one or more parameters associated with the PDCCH order. As one example, the PDCCH order DCI format may include a power control field that indicates a transmission power level associated with the PRACH. Alternatively, or additionally, the PDCCH order may indicate, by way of the power control field, an enabled retransmission state and/or a disabled retransmission state. For instance, the PDCCH order may indicate an enabled retransmission state based at least in part on the power control field specifying a transmission power level for the PRACH that is higher than a prior transmission power level associated with a prior PRACH. That is, the first network node 602 may set the power control field to a value that indicates a first transmission power level that is higher than a second transmission power level that was associated with a prior PRACH transmission by the UE 604 to the second network node 606. In some aspects, the PDCCH order may indicate a disabled retransmission state based at least in part on the transmission power level being equal to or less than the prior transmission power level.

Alternatively, or additionally, the PDCCH order DCI format may include an aggregation factor field that indicates a repetition factor associated with retransmission of a PRACH preamble. To illustrate, a repetition factor of five may indicate to retransmit the PRACH preamble five times. Accordingly, the PDCCH order may indicate, by way of the aggregation factor field, an enabled retransmission state and/or a disabled retransmission state. For instance, the PDCCH order may indicate an enabled retransmission state based at least in part on the aggregation factor field indicating a repetition factor that is greater than zero, and the PDCCH order may indicate a disabled retransmission state based at least in part on the aggregation factor field indicating a repetition factor that is equal to zero. The first network node 602 may indicate the retransmission state based at least in part on setting the aggregation factor field to a value associated with the respective retransmission state (e.g., zero for a disabled retransmission state and/or greater than zero for an enabled retransmission state).

The PDCCH order (e.g., via the PDCCH order DCI format) may include a retransmission counter field that indicates a retransmission count associated with retransmission of the PRACH. In some aspects, the retransmission counter field may be a single bit such that a first value (e.g., “0”) indicates a disabled retransmission state and a second value (e.g., “1”) indicates an enabled retransmission state. Alternatively, or additionally, the retransmission counter field may be multiple bits that may indicate a retransmission count associated with the PRACH. For example, a third value (e.g., “3”) may indicate that the PRACH associated with the PDCCH order is a third retransmission, and/or a fourth value (e.g., “4”) may indicate that the PRACH associated with the PDCCH order is a fourth retransmission of the PRACH. Accordingly, the PDCCH order may indicate an enabled retransmission state based at least in part on the retransmission counter field being configured to a value greater than zero (e.g., “1”, “3”, and/or “4”), and the PDCCH order may indicate a disabled retransmission state based at least in part on the retransmission counter field being configured to a value equal to zero.

In some aspects, the retransmission counter field may have an active state and/or an inactive state, where the retransmission counter field may indicate a retransmission state based at least in part on having an active state, and may not indicate the retransmission state based at least in part on having an inactive state. To illustrate, the retransmission counter field may have an active state based at least in part on a candidate cell that is associated with the PDCCH order being a same candidate cell that was associated with a prior PRACH transmission, and/or a synchronization signal block (SSB) associated with the PDCCH order being a same SSB that was associated with the prior PRACH transmission. Alternatively, or additionally, the retransmission counter field may have an inactive state based at least in part on the candidate cell associated with the PDCCH order not being the same candidate cell that was associated with a prior PRACH transmission, and/or the SSB associated with the PDCCH order not being the same SSB that was associated with the prior PRACH transmission. An active retransmission counter field (e.g., a retransmission counter field with an active state) may indicate a retransmission state (e.g., by being configured to a value greater than zero and/or being configured to a value equal to zero), and an inactive retransmission counter field (e.g., a retransmission counter field with an inactive state) may not be applicable to indicating the retransmission state. That is, a value of an inactive retransmission counter field may not apply to a retransmission state of a PRACH that is associated with a PDCCH order that includes the inactive retransmission counter field. Alternatively, or additionally, an inactive retransmission counter field may implicitly indicate that the PRACH is not a retransmission and/or a disabled retransmission state.

Reception of the PDCCH order may indicate the retransmission state associated with the PRACH. To illustrate, the UE 604 receiving the PDCCH order within a time window may indicate an enabled retransmission state, and the UE 604 receiving the PDCCH order outside of the time window may indicate a disabled retransmission state. One or more characteristics of the time window may be based at least in part on a variety of parameters. As one example, the time window may be based at least in part on the UE 604 receiving a prior PDCCH order (e.g., from the first network node 602). To illustrate, the UE 604 may start a countdown timer based at least in part on receiving the prior PDCCH order, and/or calculate a duration, a start time, and/or end time of the time window based at least in part on receiving the prior PDCCH order.

Alternatively, or additionally, the time window may have a valid or invalid state in a similar manner as described with regard to the retransmission counter field. For example, the time window may be valid for indicating and/or determining a retransmission state based at least in part on a candidate cell that is associated with the PDCCH order being a same candidate cell that was associated with the prior PDCCH order and/or an SSB that is associated with the PDCCH order being a same SSB that is associated with the prior PDCCH order. As another example, the time window may be invalid for indicating and/or determining the retransmission state based at least in part on the candidate cell that is associated with the PDCCH order not being the same as the candidate cell that is associated with the prior PDCCH order and/or the SSB that is associated with the PDCCH order not being the same SSB that is associated with the prior PDCCH order. To illustrate, the UE 604 may receive the PDCCH order inside of the time window, but may determine that the time window has an invalid state based at least in part on the candidate cell that is associated with the PDCCH order being different from a candidate cell associated with the prior PDCCH order and/or an SSB that is associated with the PDCCH order being different from an SSB associated with the prior PDCCH order. Accordingly, the UE 604 may determine the retransmission state using a different mechanism than the time window. Alternatively, or additionally, the time window having an invalid state may implicitly indicate a disabled retransmission state.

In some aspects, the time window may be RRC configured, such as by the first network node 602 indicating a duration of the time window, a start time of the time window, and/or an end time of the time window in an RRC message. Alternatively, or additionally, the start time of the time window may be based at least in part on a transmission time (e.g., a start-of-transmission time and/or an end-of-transmission time) associated with the UE 604 transmitting a prior PRACH that is associated with the prior PDCCH order. In some aspects, a start time of the time window may be based at least in part on a receive time (e.g., a start-of-reception time or an end-of-reception time) of the prior PDCCH order by the UE 604.

In some aspects, the PDCCH order may implicitly indicate to autonomously transmit PRACH retransmissions. That is, the UE 604 receiving the PDCCH order may implicitly indicate that the PRACH associated with the PDCCH order is a first PRACH transmission to the second network node 606 (e.g., the retransmission state associated with the PRACH is a disabled retransmission state) and to autonomously transmit one or more PRACH retransmissions after the first PRACH transmission. To illustrate, based at least in part on receiving a PDCCH order, the UE 604 may automatically configure the PRACH associated with the PDCCH order as a first PDCCH, and determine to operate in a mode that autonomously transmits subsequent PRACH retransmissions without receiving additional PDCCH orders. For example, the first network node 602 may transmit a PDCCH order to initiate transmission of a first PRACH and the UE 604 may determine to autonomously transmit subsequent PRACH retransmissions without further instruction from the first network node 602.

The network node 602 may transmit, and the UE 604 may receive, the PDCCH order message based at least in part on one or more configurations. To illustrate, a UE (e.g., the UE 604) may be configured to communicate with a network node (e.g., the network node 602) based at least in part on a control resource set (CORESET) of index 0 (e.g., CORESET #0), and the CORESET #0 may be RRC configured based at least in part on a RRC parameterfollowUnifiedTCIstate being set to an enabled state (e.g., “enabled”). In such a configuration, the CORESET #0 may also be associated with a search space (SS) of index 0, and the SS may be a Type0, Type0A, Type 0B, Type1, Type1A, Type2, and/or Type2A common search space (CSS) set. A CORESET with the above configuration (e.g., index 0 and followUnifiedTCIstate=enabled) and an association with the above SS (e.g., index 0 and one of the Types) may additionally be associated with and/or configured with (e.g., via RRC) the first or the second of the indicated joint transmission configuration indication (TCI) states and/or DL TCI states for PDCCH reception on the CORESET, otherwise, the CORESET may be associated with and/or configured with (e.g., via RRC) the first, the second, or both of the indicated joint TCI states and/or DL TCI states for PDCCH reception on the CORESET. Accordingly, in some aspects, the UE may be configured to apply the first or the second of the indicated joint transmission configuration indication (TCI) states and/or DL TCI states for PDCCH reception on the CORESET. Alternatively, or additionally, the UE may be configured to apply the first, the second, or both of the indicated joint TCI states and/or DL TCI states for PDCCH reception on the CORESET.

As described above, in some aspects, a UE (e.g., the UE 604) may be configured to communicate with a network node (e.g., the network node 602) based at least in part on a CORESET of index 0 (e.g., CORESET #0), and the CORESET #0 may be configured with a RRC parameterfollowUnifiedTCIstate=“enabled”. As also described above the CORESET #0 may also be associated with an SS of index 0, and the SS may be a Type0, Type0A, Type 0B, Type1, Type1A, Type2, and/or Type2A CSS set. A CORESET with the above configuration (e.g., index 0 and follow UnifiedTCIstate=enabled) and an association with the above SS (e.g., index 0 and one of the Types) may be associated with and/or configured with (e.g., via RRC) the first, the second, or none of the indicated joint TCI states and/or DL TCI states for the PDCCH reception on the CORESET, otherwise, the CORESET may be associated with and/or configured with (e.g., via RRC) the first, the second, both, or none of the indicated joint TCI states and/or DL TCI states for the PDCCH reception on the CORESET. In some aspects, such as scenario associated with none of the indicated TCI states being configured to be applied to the CORESET, the TCI state(s) for the PDCCH reception on the CORESET may be indicated to the UE in a separate RRC parameter. Accordingly, the UE may be configured to apply the first, the second, or none of the indicated joint TCI states and/or DL TCI states for the PDCCH reception on the CORESET, otherwise, the UE may be configured (e.g., via RRC) to apply the first, the second, both, or none of the indicated joint TCI states and/or DL TCI states for the PDCCH reception on the CORESET.

In some aspects, a UE (e.g., the UE 604) may be configured with a list of component carriers (CCs). The CCs on the list may share the same TCI state configuration, TCI state activation, and/or TCI state indication. In some examples, if a TCI state indication is targeted at a CC, the indication may be applicable to all CCs on the same CC list as the CC. Alternatively, or additionally, more than one TCI state may be associated with the CC list, and the UE may receive an indication of which TCI state(s) to apply to each of the CCs on the same CC list. As one example, the UE may receive the indication of TCI state(s) to apply in an RRC message (e.g., a bitmap in RRC). To illustrate, a CC list may include three CCs (e.g., CC1, CC2, and CC3), and the CC list may be associated with and two TCI states. In some aspects, a bitmap (e.g., in an RRC message) may specify one or more values that map a TCI state assignment to a CC in the list. For example, a first value (e.g., “00”) may indicate that a first TCI state is associated with a CC, a second value (e.g., “01”) may indicate that a second TCI state is associated with the CC, and/or a third value (e.g., “10”) may indicate that both the first TCI state and the second TCI state are associated with the CC. An ordering of the values in the bitmap may indicate an association with a particular CC within the CC list. To illustrate, a bitmap configured with the values “00 01 10” may indicate that the first TCI state indicated by the bitmap (e.g., “00”) is associated with a first CC in the CC list (e.g., CC1), that the second TCI state indicated by the bitmap (e.g., “01”) is associated with a second CC in the CC list (e.g., CC2), and the third TCI state indicated by the bitmap (e.g., “10”) are associated with the third CC in the CC list (e.g., CC3). Accordingly, an order of TCI states indicated by the bit map may implicitly indicate an association with a CC in the CC list with a same order.

In some aspects, a UE (e.g., the UE 604) may be configured to switch to multiple TRP (mTRP) mode based at least in part on identifying and/or detecting one or more trigger events. In some examples, the mTRP mode may include the UE receiving an indication of at least two DL applicable and/or UL applicable TCI states. Some non-limiting examples of a trigger event may include one or more of:
1. Receiving an mTRP TCI MAC control element (CE) activation command, and the mTRP TCI MAC CE activation command refers to and/or activates at least one activated TCI codepoint that is mapped with at least two DL applicable and/or two UL applicable TCIs, such as:
   a. a set of {first joint TCI state, second joint TCI state}
   b. a set of {first DL TCI state, first UL TCI state, second DL TCI state, second UL TCI state}
   c. a set of {first DL TCI state, first UL TCI state, second UL TCI state} and/or
   d. a set of {first DL TCI state, first UL TCI state, second DL TCI state}
2. Receiving a RRC (re)configuration
3. Receiving a TRP or cell level BRF response
4. Receiving RRC reconfiguration with sync

In some examples, a UE (e.g., the UE 604) may receive a TCI state activation and/or TCI state indication that is applicable to the mTRP mode, either before or after a trigger event that is associated with triggering the mTRP mode switch as described above. If the TCI state activation and/or TCI state indication that is applicable to mTRP mode is received before UE switches to the mTRP mode, UE may store the TCI activation and/or the TCI state indication.

In some aspects, a CC is operated in single DCI (s-DCI) mTRP mode based at least in part on and a UE (e.g., the UE 604) receiving a TCI state activation command (e.g., via a MAC CE) that activates at least one TCI codepoint mapped with more than one join TCI states, more than one DL TCI states, and/or more than one UL TCI states in the CC.

In some aspects, a CC is operated in s-DCI mTRP mode based at least in part on a UE (e.g., the UE 604) receiving a first TCI state activation command (e.g., via a MAC CE) for s-DCI based mTRP mode operation, and the first TCI state activation command is different from a second TCI state activation command (e.g., via a MAC CE) for legacy unified TCI framework of sTRP mode, in the CC.

In some aspects, a CC is operated in mTRP mode based at least in part on a UE (e.g., the UE 604) receiving a DCI indicating two DL applicable TCI states and/or UL applicable TCI states for the CC. In some aspects, a CC may be operated in mTRP mode based at least in part on the UE maintaining the two DL applicable TCI states and/or UL applicable TCI states. Alternatively, or additionally, a CC may be operated in sTRP mode based at least in part on the UE maintaining only a single DL applicable TCI state and/or UL applicable TCI state.

In some aspects, a UE capability of Layer 1 (L1) intra-frequency measurement without gap can be introduced for Layer 1 and/or Layer 2 triggered mobility. An L1 measurement gap is configured for a UE (e.g., the UE 604) in asynchronous and/or intra-frequency measurement scenario based at least in part on the UE not indicating the above capability (e.g., the L1 intra-frequency measurement without gap). In some examples, the UE may notify a network node (e.g., the network node 602) that the receiving timing difference exceeds length of a CP and/or that a L1 measurement cannot be handled without gap by the UE's capability. That is, the UE detecting the receiving timing different exceeds the length of the CP and/or that the L1 measurement cannot be handled without gap may trigger the UE to transmit a notification to the network node.

In some aspects, a UE (e.g., the UE 604) may receive a MAC CE command that instructs the UE to trigger a cell switch to a target cell. The MAC CE command may include one or more of the following examples of information:
Information to identify the target cell(s)
Cell radio network temporary identifier (C-RNTI) of the UE in the target cell or source cell
Timing advance (TA) related information
Beam Indication for the target cell
Active DL and UL bandwidth part (BWP) for the target cell
   Accordingly, the MAC CE command may exclude one or more of the above examples of information and/or one or more of the above examples of information may be optionally present. For instance, one or more of the above examples of information may only present when configured at the UE (e.g., the UE is instructed that the MAC CE command will include the information).

In some aspects, the active DL and UL BWP for a target special cell (SpCell), within the cell switch command may be indicated by at least one of the following manners:
configured in a RRC field of an active DL BWP identifier (ID) and UL BWP ID
indicated through an active BWP ID associating with an indicated TCI state
indicated through at least one of:
   firstActiveDownlinkBWP-Id and firstActiveUplinkBWP-Id in CellGroupConfig, and/or
   the active BWP ID associating with the indicated TCI state
      For instance, the active BWP information may be indicated firstActiveDownlinkBWP-Id and firstActiveUplinkBWP-Id in CellGroupConfig for target cell. If the TCI state indicated in cell switch command is associated with a BWP different from those provided by CellGroupConfig, the active BWP ID associating with the indicated TCI state may be additionally indicated in cell switch command.

In some aspects, a UE (e.g., the UE 604) may select a subset of the reported SSB from target cells for storing and/or maintaining DL synchronization timing information and/or path loss estimation. In some examples, the SSB subset selection may be indicated explicitly by gNB signalling, such as RRC signalling or MAC CE signalling. Alternatively, or additionally, the SSB subset selection may be performed by the UE. To illustrate, the UE may store and/or maintain DL synchronization timing information for the N strongest SSBs (e.g., based on UE capability) based on the measurement results and/or measurement reports, where N is an integer. The total number of SSBs that the UE may store and/or maintain DL synchronization timing information for may be based at least in part on a UE capability.

In some aspects, a UE (e.g., the UE 604) may determine the beam indication for a CORESET #0 and a Type 0A/1/2-PDCCH CSS sets in a target cell based at least in part on at least one of the following approaches:
Follow the indicated TCI state in the cell switch command until configured a new TCI state
An additional TCI state is signalled in the cell switch command, if the CORESET #0 and Type 0A/1/2 PDCCH CSS are to follow a different TCI state from the indicated TCI
Follow the SSB index indicated by the cell switch command or a previous PDCCH order for the target cell
After cell switch, the beam indication will be configured by the target cell following legacy way
   In some aspects, the UE may receive an indication of a reference signal (RS) identifier for the purpose of TCI state indication and/or TCI state activation. In some aspects, a mapping between the indicated RS identifier and the indicated and/or activated TCI state ID may be performed by the UE following a predefined rule. In some example, the mapping may be indicated by a network node. To illustrate, the mapping may be preconfigured via RRC signalling before the RS identifier indication.

As shown by reference number 620, the UE 604 may transmit, and the second network node 606 may receive, a PRACH. Accordingly, the UE 604 may transmit a PRACH that is associated with a candidate cell instead of transmitting a PRACH that is associated with the network node (e.g., the first network node 602 and/or an spCell) that transmitted the PDCCH order to the UE 604. While FIG. 6 shows the second network node 606 receiving the PRACH, other examples may include the second network node 606 not receiving the PRACH. In some aspects, the UE 604 may transmit the PRACH based at least in part on a retransmission state indicated by the PDCCH order and as described with regard to reference number 610.

The UE 604 may transmit the PRACH based at least in part on using a transmission power level that is indicated by a power control field included in the PDCCH order. As one example, the UE 604 may transmit the PRACH as a PRACH retransmission to the second network node 606 based at least in part on the transmission power level being higher than a prior transmission power level associated with a prior PRACH transmission. As another example, the UE 604 may transmit the PRACH as a first PRACH transmission to the second network node 606 based at least in part on the transmission power level being equal to or less than the prior transmission power level.

In some aspects, the UE 604 may transmit the PRACH based at least in part on a repetition factor indicated in an aggregation factor field included in the PDCCH order. For example, the UE 604 may transmit the PRACH and/or the PRACH preamble for a repetition factor number of times. To illustrate, the repetition factor indicated by the aggregation factor field may be N, where N is an integer, and the UE 604 may transmit and/or retransmit the PRACH preamble N times (e.g., including the first PRACH transmission).

In transmitting the PRACH, the UE 604 may calculate a transmission power level that is increased from a prior transmission power level associated with a prior PRACH transmission. For example, based at least in part on the PDCCH order indicating an enabled retransmission state, the UE 604 may calculate the increased transmission power level, and transmit the PRACH based at least in part on using the increased transmission power level. Alternatively, or additionally, the UE 604 may use an initial transmission power level for transmitting the PRACH based at least in part on the PDCCH order indicating a disabled retransmission state.

In some aspects, and as shown by reference number 630, the UE 604 may autonomously transmit PRACH retransmissions. As one example, the UE 604 may receive a first PRACH order, as described with regard to reference number 610, that indicates to transmit an initial and/or first PRACH to the second network node 606 and, after failing to receive an RAR from the second network node 606, the UE 604 may autonomously transmit one or more PRACH retransmissions without receiving an additional and/or second PDCCH order from the first network node 602. The UE 604 may autonomously transmit PRACH retransmissions based at least in part on a maximum number of allowed PRACH transmissions, such as a maximum number of allowed PRACH transmissions indicated by the first network node 602 in random access configuration information. The PRACH retransmission(s) may be based at least in part on the initial PRACH transmission directed to the second network node 606.

In other aspects, autonomous transmission of PRACH retransmissions may be disallowed, and the UE 604 may refrain from autonomously transmitting a PRACH retransmission. To illustrate, the UE 604 may only transmit a PRACH retransmission based at least in part on receiving an additional PDCCH order that indicates an enabled retransmission state. Accordingly, in some examples, the UE 604 may not autonomously transmit PRACH retransmissions as described with regard to reference number 630.

As shown by reference number 640, the second network node 606 may transmit, and the first network node 602 may receive, a PRACH status indication. To illustrate, the second network node 606 may communicate with the first network node 602 based at least in part on using a backhaul link, and the PRACH status indication may indicate a failure status (e.g., a failure in receiving a PRACH) or a success status (e.g., a success in receiving a PRACH). The PRACH status indication may be an explicit message associated with indicating a PRACH status and/or an implicit message. To illustrate an implicit message, the second network node 606 may indicate a failure status based at least in part on refraining from transmitting a PRACH status indication within a time window. While FIG. 6 shows the second network node 606 transmitting a PRACH status indication to the first network node 602 in the example 600, the second network node 606 may not transmit a PRACH status indication to the first network node 602 in other examples.

As shown by reference number 650-1, the first network node 602 may iteratively transmit, and the UE 604 may iteratively receive, one or more additional PDCCH orders that are associated with the second network node 606. For instance, and as described above, the first network node 602 may transmit a PDCCH order that indicates an enabled retransmission state. Based at least in part on receiving the additional PDCCH order(s), the UE 604 may transmit a PRACH retransmission to the second network node 606, as described with regard to reference number 620, and/or the second network node 606 may transmit a PRACH status indication, as described with regard to reference number 640.

While FIG. 6 shows that the first network node 602 may transmit additional PDCCH order(s) in the example 600, the first network node 602 may refrain from transmitting an additional PDCCH order to trigger a PRACH retransmission in other examples. To illustrate, the UE 604 may be configured to autonomously transmit PRACH retransmissions, as described with regard to reference number 630, and the first network node 602 may refrain from transmitting the additional PDCCH order and, subsequently, may preserve air interface resources for other purposes.

Alternatively, or additionally, as shown by reference number 650-2, the first network node 602 may transmit, and the UE 604 may receive, a termination instruction to terminate autonomous transmission of the PRACH retransmissions. As an example, the first network node 602 may transmit, as the termination instruction, a PDCCH that includes scrambling specific to indicating the termination instruction, a timing advance command associated with the second network node 606, and/or a cell switch command that is associated with the candidate cell. That is, the PDCCH with specific scrambling, the timing advance command, and/or the cell switch command may implicitly indicate to terminate the autonomous transmission of the PRACH retransmissions. Accordingly, the UE 604 may receive, prior to transmitting the maximum number of allowed PRACH retransmissions, the termination instruction associated with autonomous transmission of the PRACH retransmissions, and may subsequently refrain from transmitting an additional PRACH retransmission to the second network node 606 (e.g., the candidate cell and/or the candidate network node). Stopping transmission of the PRACH retransmissions prior to transmitting an entirety of the maximum number of allowed PRACH retransmissions may preserve air interface resources for other purposes.

A network node transmitting, and a UE receiving, a PDCCH order that indicates a retransmission state associated with a PRACH directed to a candidate cell may preserve UE resources (e.g., battery power, memory, and/or processor resources) and/or air interface resources of a wireless network. To illustrate, the PDCCH order indicating a retransmission state may resolve a transmission power level ambiguity at the UE, and enable the UE to use a transmission power level for transmitting a PRACH that results in a candidate network node receiving the PRACH and/or additional PRACH (re)transmissions with fewer transmissions by the UE. In some aspects, the UE may autonomously transmit PRACH retransmission(s), and the network node may instruct the UE to cease transmitting the PRACH retransmission(s), which may also result in fewer transmissions by the UE. Fewer transmissions by the UE may reduce a consumption of UE resources to preserve a battery power and/or computing resources of the UE for additional purposes. Alternatively, or additionally, fewer transmissions by the UE may reduce a consumption of air interface resources by the UE and/or may preserve the air interface resources for use by other devices. Preserving the air interface resources for use by other devices may increase data throughput and/or reduce data transfer latencies within a wireless network.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with retransmissions associated with a PDCCH ordered RACH procedure.

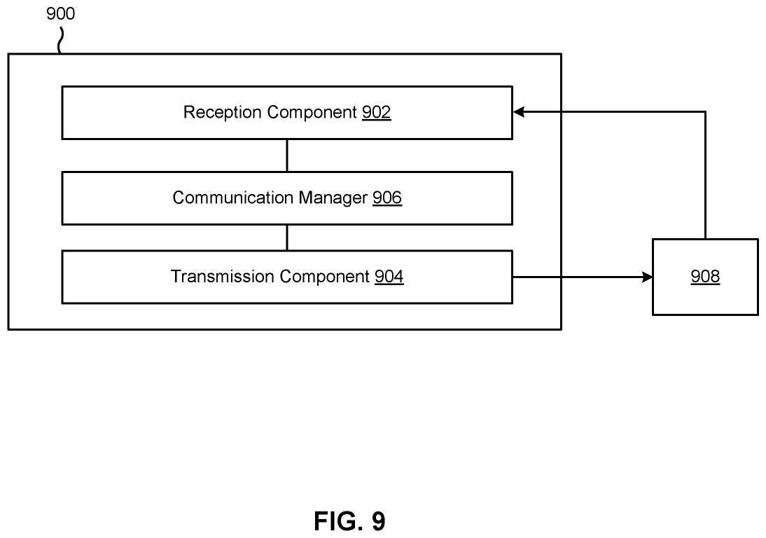

As shown in FIG. 7, in some aspects, process 700 may include receiving a PDCCH order that indicates to perform a RACH procedure that is associated with a candidate cell and is not associated with a configured RAR, the PDCCH order indicating a retransmission state associated with a PRACH message that is associated with the candidate cell (block 710). For example, the UE (e.g., using reception component 902 and/or communication manager 906, depicted in FIG. 9) may receive a PDCCH order that indicates to perform a RACH procedure that is associated with a candidate cell and is not associated with a configured RAR, the PDCCH order indicating a retransmission state associated with a PRACH message that is associated with the candidate cell, as described above.

As further shown in FIG. 7, in some aspects, process 700 may include transmitting the PRACH message that is associated with the candidate cell based at least in part on the retransmission state (block 720). For example, the UE (e.g., using transmission component 904 and/or communication manager 906, depicted in FIG. 9) may transmit the PRACH message that is associated with the candidate cell based at least in part on the retransmission state, as described above.

Process 700 may include additional aspects, such as any single aspect or any combination of aspects described below and/or in connection with one or more other processes described elsewhere herein.

In a first aspect, receiving the PDCCH order includes receiving the PDCCH order in DCI that is based at least in part on a PDCCH order DCI format.

In a second aspect, transmitting the PRACH message is based at least in part on receiving the PDCCH order.

In a third aspect, the PDCCH order DCI format includes a power control field that indicates a transmission power level associated with the PRACH message.

In a fourth aspect, transmitting the PRACH message includes transmitting the PRACH message based at least in part on using the transmission power level that is indicated by the power control field.

In a fifth aspect, the transmission power level is higher than a prior transmission power level associated with a prior PRACH transmission, and the PDCCH order indicates an enabled retransmission state based at least in part on the transmission power level being higher than the prior transmission power level.

In a sixth aspect, the transmission power level is equal to or less than a prior transmission power level associated with a prior PRACH transmission, and the PDCCH order indicates a disabled retransmission state based at least in part on the transmission power level being equal to or less than the prior transmission power level.

In a seventh aspect, the PDCCH order DCI format includes an aggregation factor field that indicates a repetition factor associated with retransmission of a PRACH preamble.

In an eighth aspect, transmitting the PRACH message includes transmitting the PRACH preamble based at least in part on the repetition factor.

In a ninth aspect, the repetition factor is greater than zero, and the PDCCH order indicates an enabled retransmission state based at least in part on the repetition factor being greater than zero.

In a tenth aspect, the repetition factor is equal to zero, and the PDCCH order indicates a disabled retransmission state based at least in part on the repetition factor being equal to zero.

In an eleventh aspect, the PDCCH order DCI format includes a retransmission counter field that indicates a retransmission count associated with retransmission of the PRACH message.

In a twelfth aspect, the retransmission counter field indicates a value greater than zero, and the PDCCH order indicates an enabled retransmission state based at least in part on the retransmission counter field being configured to the value greater than zero.

In a thirteenth aspect, the retransmission counter field has an active state based at least in part on the candidate cell associated with the PDCCH order being a same candidate cell that was associated with a prior PRACH transmission.

In a fourteenth aspect, the retransmission counter field has an active state based at least in part on an SSB associated with the PDCCH order being a same SSB that was associated with a prior PRACH transmission.

In a fifteenth aspect, process 700 includes calculating a transmission power level that is increased from a prior transmission power level associated with a prior PRACH transmission based at least in part on the enabled retransmission state, and transmitting the PRACH message includes transmitting the PRACH message based at least in part on using the transmission power level that is increased from the prior transmission power level.

In a sixteenth aspect, receiving the PDCCH order includes receiving the PDCCH order within a time window that is associated with receiving a prior PDCCH order, and the PDCCH order indicates an enabled retransmission state based at least in part on receiving the PDCCH order within the time window.

In a seventeenth aspect, the candidate cell that is associated with the PDCCH order is a same candidate cell that was associated with the prior PDCCH order, and the PDCCH order indicates the enabled retransmission state based at least in part on the candidate cell being the same candidate cell that was associated with the prior PDCCH order.

In an eighteenth aspect, an SSB that is associated with the PDCCH order is a same SSB that was associated with the prior PDCCH order, and the PDCCH order indicates the enabled retransmission state based at least in part on the SSB being the same SSB that was associated with the prior PDCCH order.

In a nineteenth aspect, a duration of the time window is RRC configured.

In a twentieth aspect, a start time of the time window is based at least in part on a transmission time of a prior PRACH transmission that is associated with the prior PDCCH order.

In a twenty-first aspect, a start time of the time window is based at least in part on a receive time of the prior PDCCH order.

In a twenty-second aspect, receiving the PDCCH order includes receiving the PDCCH order outside of a time window that is associated with receiving a prior PDCCH order, and the PDCCH order indicates a disabled retransmission state based at least in part on receiving the PDCCH order outside of the time window.

In a twenty-third aspect, receiving the PDCCH order includes receiving the PDCCH order inside of a time window that is associated with receiving a prior PDCCH order, and the PDCCH order indicates a disabled retransmission state based at least in part on at least one of: the candidate cell that is associated with the PDCCH order is a first candidate cell that is different from a second candidate cell that was associated with the prior PDCCH order, or a first SSB that is associated with the PDCCH order is different from a second SSB that was associated with the prior PDCCH order.

In a twenty-fourth aspect, the PDCCH order indicates a disabled retransmission state for the PDCCH, and process 700 includes transmitting, autonomously and without receiving another PDCCH order, one or more PRACH retransmissions based at least in part on a maximum number of allowed PRACH transmissions, the one or more PRACH retransmissions being based at least in part on the PRACH message.

In a twenty-fifth aspect, process 700 includes receiving, prior to transmitting the maximum number of allowed PRACH transmissions, a termination instruction for terminating autonomous transmission of the one or more PRACH retransmissions, and refraining from transmitting an additional PRACH retransmission that is based at least in part on the PRACH message.

In a twenty-sixth aspect, receiving the termination instruction includes receiving at least one of a PDCCH that includes scrambling associated with indicating the termination instruction, a timing advance command associated with the candidate cell, or a cell switch command that is associated with the candidate cell.

In a twenty-seventh aspect, process 700 includes receiving an indication of the maximum number of allowed PRACH retransmissions from a network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with retransmissions associated with a PDCCH ordered RACH procedure.

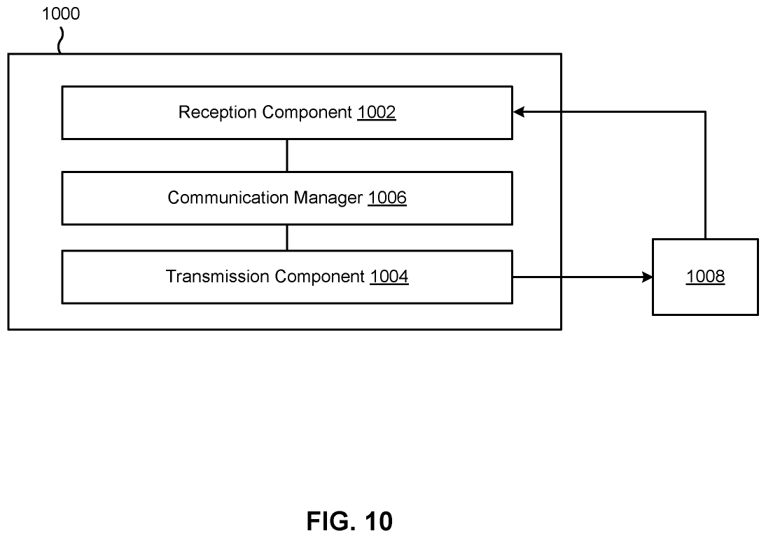

As shown in FIG. 8, in some aspects, process 800 may include transmitting a PDCCH order associated with performing a RACH procedure that is associated with a candidate cell and is not associated with a configured RAR, the PDCCH order indicating a retransmission state associated with a PRACH message that is associated with the candidate cell (block 810). For example, the network node (e.g., using transmission component 1004 and/or communication manager 1006, depicted in FIG. 10) may transmit a PDCCH order associated with performing a RACH procedure that is associated with a candidate cell and is not associated with a configured RAR, the PDCCH order indicating a retransmission state associated with a PRACH message that is associated with the candidate cell, as described above.

Process 800 may include additional aspects, such as any single aspect or any combination of aspects described below and/or in connection with one or more other processes described elsewhere herein.

In a first aspect, transmitting the PDCCH order includes transmitting the PDCCH order in DCI and based at least in part on a PDCCH order DCI format.

In a second aspect, the PDCCH order DCI format includes a power control field that indicates a transmission power level associated with the PRACH message.

In a third aspect, the transmission power level is higher than a prior transmission power level associated with a prior PRACH transmission, and the PDCCH order indicates an enabled retransmission state based at least in part on the transmission power level being higher than the prior transmission power level.

In a fourth aspect, the transmission power level is equal to or less than a prior transmission power level associated with a prior PRACH transmission, and the PDCCH order indicates a disabled retransmission state based at least in part on the transmission power level being equal to or less than the prior transmission power level.

In a fifth aspect, the PDCCH order DCI format includes an aggregation factor field that indicates a repetition factor associated with retransmission of a PRACH preamble.

In a sixth aspect, the repetition factor is greater than zero, and the PDCCH order indicates an enabled retransmission state based at least in part on the repetition factor being greater than zero.

In a seventh aspect, the repetition factor is equal to zero, and the PDCCH order indicates a disabled retransmission state based at least in part on the repetition factor being equal to zero.

In an eighth aspect, the PDCCH order DCI format includes a retransmission counter field that indicates a retransmission count associated with retransmission of the PRACH message.

In a ninth aspect, the retransmission counter field indicates a value greater than zero, and the PDCCH order indicates an enabled retransmission state based at least in part on the retransmission counter field being configured to the value greater than zero.

In a tenth aspect, the retransmission counter field has an active state based at least in part on the candidate cell associated with the PDCCH order being a same candidate cell that was associated with a prior PRACH transmission.

In an eleventh aspect, the retransmission counter field has an active state based at least in part on based at least in part on an SSB associated with the PDCCH order being a same SSB that was associated with a prior PRACH transmission.

In a twelfth aspect, transmitting the PDCCH order includes transmitting the PDCCH order within a time window that is associated with transmitting a prior PDCCH order, and the PDCCH order indicates an enabled retransmission state based at least in part on transmitting the PDCCH order within the time window.

In a thirteenth aspect, the candidate cell that is associated with the PDCCH order is a same candidate cell that was associated with the prior PDCCH order, and the PDCCH order indicates the enabled retransmission state based at least in part on the candidate cell being the same candidate cell that was associated with the prior PDCCH order.

In a fourteenth aspect, an SSB that is associated with the PDCCH order is a same SSB that was associated with the prior PDCCH order, and the PDCCH order indicates the enabled retransmission state based at least in part on the SSB being the same SSB that was associated with the prior PDCCH order.

In a fifteenth aspect, process 800 includes transmitting a duration of the time window in an RRC message.

In a sixteenth aspect, a start time of the time window is based at least in part on a transmission time of a prior PRACH transmission that is associated with the prior PDCCH order.

In a seventeenth aspect, a start time of the time window is based at least in part on a receive time of the prior PDCCH order.

In an eighteenth aspect, transmitting the PDCCH order includes transmitting the PDCCH order outside of a time window that is associated with transmitting a prior PDCCH order, and the PDCCH order indicates a disabled retransmission state based at least in part on transmitting the PDCCH order outside of the time window.

In a nineteenth aspect, transmitting the PDCCH order includes transmitting the PDCCH order inside of a time window that is associated with transmitting a prior PDCCH order, and the PDCCH order indicates a disabled retransmission state based at least in part on at least one of: the candidate cell that is associated with the PDCCH order is a first candidate cell that is different from a second candidate cell that was associated with the prior PDCCH order, or a first synchronization signal block (SSB) that is associated with the PDCCH order is different from a second SSB that was associated with the prior PDCCH order.

In a twentieth aspect, the PDCCH order indicates a disabled retransmission state for the PRACH message, and autonomous PRACH retransmissions that are based at least in part on a maximum number of allowed PRACH retransmissions.

In a twenty-first aspect, process 800 includes transmitting a termination instruction associated with terminating the autonomous PRACH retransmissions.

In a twenty-second aspect, transmitting the termination instruction includes transmitting at least one of a PDCCH that includes scrambling specific to indicating the termination instruction, a timing advance command associated with the candidate cell, or a cell switch command that is associated with the candidate cell.

In a twenty-third aspect, process 800 includes transmitting an indication of the maximum number of allowed PRACH retransmissions.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5-8. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may receive, by way of the reception component 902, a PDCCH order that indicates to perform a RACH procedure that is associated with a candidate cell and is not associated with a configured RAR, the PDCCH order indicating a retransmission state associated with a PRACH message that is associated with the candidate cell. The communication manager 906 may transmit, by way of the transmission component 904, the PRACH message that is associated with the candidate cell based at least in part on the retransmission state.

The communication manager 906 may calculate a transmission power level that is increased from a prior transmission power level associated with a prior PRACH transmission based at least in part on the enabled retransmission state.

The communication manager 906 may receive, by way of the reception component 902 and prior to transmitting the maximum number of allowed PRACH transmissions, a termination instruction for terminating autonomous transmission of the one or more PRACH retransmissions.

The communication manager 906 may refrain from transmitting an additional PRACH retransmission that is based at least in part on the PRACH message.

The communication manager 906 may receive, by way of the reception component 902, an indication of the maximum number of allowed PRACH retransmissions from a network node.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5-8. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may transmit, by way of the transmission component 1004, a PDCCH order associated with performing a RACH procedure that is associated with a candidate cell and is not associated with a configured RAR, the PDCCH order indicating a retransmission state associated with a PRACH message that is associated with the candidate cell.

The communication manager 1006 may transmit, by way of the transmission component 1004, a duration of the time window in an RRC message.

The communication manager 1006 may transmit, by way of the transmission component 1004, a termination instruction associated with terminating the autonomous PRACH retransmissions.

The communication manager 1006 may transmit, by way of the transmission component 1004, an indication of the maximum number of allowed PRACH retransmissions.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a physical downlink control channel (PDCCH) order that indicates to perform a random access channel (RACH) procedure that is associated with a candidate cell and is not associated with a configured random access response (RAR), the PDCCH order indicating a retransmission state associated with a physical random access channel (PRACH) message that is associated with the candidate cell; and transmitting the PRACH message that is associated with the candidate cell based at least in part on the retransmission state.

Aspect 2: The method of Aspect 1, wherein receiving the PDCCH order comprises: receiving the PDCCH order in downlink control information (DCI) that is based at least in part on a PDCCH order DCI format.

Aspect 3: The method of Aspect 2, wherein transmitting the PRACH message is based at least in part on receiving the PDCCH order.

Aspect 4: The method of Aspect 2, wherein the PDCCH order DCI format includes a power control field that indicates a transmission power level associated with the PRACH message.

Aspect 5: The method of Aspect 4, wherein transmitting the PRACH message comprises: transmitting the PRACH message based at least in part on using the transmission power level that is indicated by the power control field.

Aspect 6: The method of Aspect 5, wherein the transmission power level is higher than a prior transmission power level associated with a prior PRACH transmission, and wherein the PDCCH order indicates an enabled retransmission state based at least in part on the transmission power level being higher than the prior transmission power level.

Aspect 7: The method of Aspect 5, wherein the transmission power level is equal to or less than a prior transmission power level associated with a prior PRACH transmission, and wherein the PDCCH order indicates a disabled retransmission state based at least in part on the transmission power level being equal to or less than the prior transmission power level.

Aspect 8: The method of Aspect 2, wherein the PDCCH order DCI format includes an aggregation factor field that indicates a repetition factor associated with retransmission of a PRACH preamble.

Aspect 9: The method of Aspect 8, wherein transmitting the PRACH message comprises: transmitting the PRACH preamble based at least in part on the repetition factor.

Aspect 10: The method of Aspect 8, wherein the repetition factor is greater than zero, and wherein the PDCCH order indicates an enabled retransmission state based at least in part on the repetition factor being greater than zero.

Aspect 11: The method of Aspect 8, wherein the repetition factor is equal to zero, and wherein the PDCCH order indicates a disabled retransmission state based at least in part on the repetition factor being equal to zero.

Aspect 12: The method of Aspect 2, wherein the PDCCH order DCI format includes a retransmission counter field that indicates a retransmission count associated with retransmission of the PRACH message.

Aspect 13: The method of Aspect 12, wherein the retransmission counter field indicates a value greater than zero, and wherein the PDCCH order indicates an enabled retransmission state based at least in part on the retransmission counter field being configured to the value greater than zero.

Aspect 14: The method of Aspect 13, wherein the retransmission counter field has an active state based at least in part on the candidate cell associated with the PDCCH order being a same candidate cell that was associated with a prior PRACH transmission.

Aspect 15: The method of Aspect 13, wherein the retransmission counter field has an active state based at least in part on a synchronization signal block (SSB) associated with the PDCCH order being a same SSB that was associated with a prior PRACH transmission.

Aspect 16: The method of Aspect 13, further comprising: calculating a transmission power level that is increased from a prior transmission power level associated with a prior PRACH transmission based at least in part on the enabled retransmission state, wherein transmitting the PRACH message comprises: transmitting the PRACH message based at least in part on using the transmission power level that is increased from the prior transmission power level. wherein transmitting the PRACH message comprises: transmitting the PRACH message based at least in part on using the transmission power level that is increased from the prior transmission power level.

Aspect 17: The method of any of Aspects 1-16, wherein receiving the PDCCH order comprises: receiving the PDCCH order within a time window that is associated with receiving a prior PDCCH order, wherein the PDCCH order indicates an enabled retransmission state based at least in part on receiving the PDCCH order within the time window.

Aspect 18: The method of Aspect 17, wherein the candidate cell that is associated with the PDCCH order is a same candidate cell that was associated with the prior PDCCH order, and wherein the PDCCH order indicates the enabled retransmission state based at least in part on the candidate cell being the same candidate cell that was associated with the prior PDCCH order.

Aspect 19: The method of Aspect 17, wherein a synchronization signal block (SSB) that is associated with the PDCCH order is a same SSB that was associated with the prior PDCCH order, and wherein the PDCCH order indicates the enabled retransmission state based at least in part on the SSB being the same SSB that was associated with the prior PDCCH order.

Aspect 20: The method of Aspect 17, wherein a duration of the time window is radio resource control (RRC) configured.

Aspect 21: The method of Aspect 17, wherein a start time of the time window is based at least in part on a transmission time of a prior PRACH transmission that is associated with the prior PDCCH order.

Aspect 22: The method of Aspect 17, wherein a start time of the time window is based at least in part on a receive time of the prior PDCCH order.

Aspect 23: The method of any of Aspects 1-22, wherein receiving the PDCCH order comprises: receiving the PDCCH order outside of a time window that is associated with receiving a prior PDCCH order, wherein the PDCCH order indicates a disabled retransmission state based at least in part on receiving the PDCCH order outside of the time window.

Aspect 24: The method of any of Aspects 1-23, wherein receiving the PDCCH order comprises: receiving the PDCCH order inside of a time window that is associated with receiving a prior PDCCH order, wherein the PDCCH order indicates a disabled retransmission state based at least in part on at least one of: the candidate cell that is associated with the PDCCH order is a first candidate cell that is different from a second candidate cell that was associated with the prior PDCCH order, or a first synchronization signal block (SSB) that is associated with the PDCCH order is different from a second SSB that was associated with the prior PDCCH order.

Aspect 25: The method of any of Aspects 1-24, wherein the PDCCH order indicates a disabled retransmission state for the PDCCH, and the method further comprises: transmitting, autonomously and without receiving another PDCCH order, one or more PRACH retransmissions based at least in part on a maximum number of allowed PRACH transmissions, the one or more PRACH retransmissions being based at least in part on the PRACH message.

Aspect 26: The method of Aspect 25, further comprising: receiving, prior to transmitting the maximum number of allowed PRACH transmissions, a termination instruction for terminating autonomous transmission of the one or more PRACH retransmissions; and refraining from transmitting an additional PRACH retransmission that is based at least in part on the PRACH message.

Aspect 27: The method of Aspect 26, wherein receiving the termination instruction comprises: receiving at least one of: a PDCCH that includes scrambling associated with indicating the termination instruction, a timing advance command associated with the candidate cell, or a cell switch command that is associated with the candidate cell.

Aspect 28: The method of Aspect 25, further comprising: receiving an indication of the maximum number of allowed PRACH retransmissions from a network node.

Aspect 29: The method of any one of Aspects 1-28, further comprising: increasing, incrementally, a respective transmission power level of each subsequent PRACH retransmission based at least in part on the PDCCH order indicating an enabled retransmission state; and transmitting each subsequent PRACH retransmission using the respective transmission power level based at least in part on the PDCCH order indicating the enabled retransmission state.

Aspect 30: The method of any one of Aspects 1-28, wherein the PDCCH order includes a retransmission count field that indicates, as the retransmission state, one of: a disabled retransmission state based at least in part on being set to a first value, or an enabled retransmission state based at least in part on being set to a second value.

Aspect 31: The method of any one of Aspects 1-20, wherein transmitting the PRACH message comprises: transmitting the PRACH message using an initial transmission power level based at least in part on the PDCCH order indicating a disabled retransmission state.

Aspect 32: A method of wireless communication performed by a network node, comprising: transmitting a physical downlink control channel (PDCCH) order associated with performing a random access channel (RACH) procedure that is associated with a candidate cell and is not associated with a configured random access response (RAR), the PDCCH order indicating a retransmission state associated with a physical random access channel (PRACH) message that is associated with the candidate cell.

Aspect 33: The method of Aspect 32, wherein transmitting the PDCCH order comprises: transmitting the PDCCH order in downlink control information (DCI) and based at least in part on a PDCCH order DCI format.

Aspect 34: The method of Aspect 33, wherein the PDCCH order DCI format includes a power control field that indicates a transmission power level associated with the PRACH message.

Aspect 35: The method of Aspect 34, wherein the transmission power level is higher than a prior transmission power level associated with a prior PRACH transmission, and wherein the PDCCH order indicates an enabled retransmission state based at least in part on the transmission power level being higher than the prior transmission power level.

Aspect 36: The method of Aspect 34, wherein the transmission power level is equal to or less than a prior transmission power level associated with a prior PRACH transmission, and wherein the PDCCH order indicates a disabled retransmission state based at least in part on the transmission power level being equal to or less than the prior transmission power level.

Aspect 37: The method of Aspect 33, wherein the PDCCH order DCI format includes an aggregation factor field that indicates a repetition factor associated with retransmission of a PRACH preamble.

Aspect 38: The method of Aspect 37, wherein the repetition factor is greater than zero, and wherein the PDCCH order indicates an enabled retransmission state based at least in part on the repetition factor being greater than zero.

Aspect 39: The method of Aspect 37, wherein the repetition factor is equal to zero, and wherein the PDCCH order indicates a disabled retransmission state based at least in part on the repetition factor being equal to zero.

Aspect 40: The method of Aspect 33, wherein the PDCCH order DCI format includes a retransmission counter field that indicates a retransmission count associated with retransmission of the PRACH message.

Aspect 41: The method of Aspect 40, wherein the retransmission counter field indicates a value greater than zero, and wherein the PDCCH order indicates an enabled retransmission state based at least in part on the retransmission counter field being configured to the value greater than zero.

Aspect 42: The method of Aspect 41, wherein the retransmission counter field has an active state based at least in part on the candidate cell associated with the PDCCH order being a same candidate cell that was associated with a prior PRACH transmission.

Aspect 43: The method of Aspect 41, wherein the retransmission counter field has an active state based at least in part on based at least in part on a synchronization signal block (SSB) associated with the PDCCH order being a same SSB that was associated with a prior PRACH transmission.

Aspect 44: The method of any of Aspects 32-43, wherein transmitting the PDCCH order comprises: transmitting the PDCCH order within a time window that is associated with transmitting a prior PDCCH order, wherein the PDCCH order indicates an enabled retransmission state based at least in part on transmitting the PDCCH order within the time window.

Aspect 45: The method of Aspect 44, wherein the candidate cell that is associated with the PDCCH order is a same candidate cell that was associated with the prior PDCCH order, and wherein the PDCCH order indicates the enabled retransmission state based at least in part on the candidate cell being the same candidate cell that was associated with the prior PDCCH order.

Aspect 46: The method of Aspect 44, wherein a synchronization signal block (SSB) that is associated with the PDCCH order is a same SSB that was associated with the prior PDCCH order, and wherein the PDCCH order indicates the enabled retransmission state based at least in part on the SSB being the same SSB that was associated with the prior PDCCH order.

Aspect 47: The method of Aspect 44, further comprising: transmitting a duration of the time window in a radio resource control (RRC) message.

Aspect 48: The method of Aspect 44, wherein a start time of the time window is based at least in part on a transmission time of a prior PRACH transmission that is associated with the prior PDCCH order.

Aspect 49: The method of Aspect 44, wherein a start time of the time window is based at least in part on a receive time of the prior PDCCH order.

Aspect 50: The method of any of Aspects 32-49, wherein transmitting the PDCCH order comprises: transmitting the PDCCH order outside of a time window that is associated with transmitting a prior PDCCH order, wherein the PDCCH order indicates a disabled retransmission state based at least in part on transmitting the PDCCH order outside of the time window.

Aspect 51: The method of any of Aspects 32-50, wherein transmitting the PDCCH order comprises: transmitting the PDCCH order inside of a time window that is associated with transmitting a prior PDCCH order, wherein the PDCCH order indicates a disabled retransmission state based at least in part on at least one of: the candidate cell that is associated with the PDCCH order is a first candidate cell that is different from a second candidate cell that was associated with the prior PDCCH order, or a first synchronization signal block (SSB) that is associated with the PDCCH order is different from a second SSB that was associated with the prior PDCCH order.

Aspect 52: The method of any of Aspects 32-51, wherein the PDCCH order indicates: a disabled retransmission state for the PRACH message, and autonomous PRACH retransmissions that are based at least in part on a maximum number of allowed PRACH retransmissions.

Aspect 53: The method of Aspect 52, further comprising: transmitting a termination instruction associated with terminating the autonomous PRACH retransmissions.

Aspect 54: The method of Aspect 53, wherein transmitting the termination instruction comprises: transmitting at least one of: a PDCCH that includes scrambling specific to indicating the termination instruction, a timing advance command associated with the candidate cell, or a cell switch command that is associated with the candidate cell.

Aspect 55: The method of any of Aspect 32-54, wherein the PDCCH order includes a retransmission count field that indicates, as the retransmission state, one of: a disabled retransmission state based at least in part on being set to a first value, or an enabled retransmission state based at least in part on being set to a second value.

Aspect 56: The method of Aspect 49, further comprising: transmitting an indication of the maximum number of allowed PRACH retransmissions.

Aspect 57: An apparatus for wireless communication at a device, comprising a processor; memory coupled with the processor; and instructions stored in the memory and executable by the processor to cause the apparatus to perform the method of one or more of Aspects 1-31.

Aspect 58: An apparatus for wireless communication at a device, comprising a processor; memory coupled with the processor; and instructions stored in the memory and executable by the processor to cause the apparatus to perform the method of one or more of Aspects 32-56.

Aspect 59: A device for wireless communication, comprising a memory and one or more processors coupled to the memory, the one or more processors configured individually or in any combination, to perform the method of one or more of Aspects 1-31.

Aspect 60: A device for wireless communication, comprising a memory and one or more processors coupled to the memory, the one or more processors configured, individually or in any combination, to perform the method of one or more of Aspects 32-56.

Aspect 61: An apparatus for wireless communication, comprising at least one means for performing the method of one or more of Aspects 1-31.

Aspect 62: An apparatus for wireless communication, comprising at least one means for performing the method of one or more of Aspects 32-56.

Aspect 63: A non-transitory computer-readable medium storing code for wireless communication, the code comprising instructions executable by a processor to perform the method of one or more of Aspects 1-31.

Aspect 64: A non-transitory computer-readable medium storing code for wireless communication, the code comprising instructions executable by a processor to perform the method of one or more of Aspects 32-56.

Aspect 65: A non-transitory computer-readable medium storing a set of instructions for wireless communication, the set of instructions comprising one or more instructions that, when executed by one or more processors of a device, cause the device to perform the method of one or more of Aspects 1-31.

Aspect 66: A non-transitory computer-readable medium storing a set of instructions for wireless communication, the set of instructions comprising one or more instructions that, when executed by one or more processors of a device, cause the device to perform the method of one or more of Aspects 32-56.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
receive a physical downlink control channel (PDCCH) order that indicates to perform a random access channel (RACH) procedure that is associated with a candidate cell and is not associated with a configured random access response (RAR), the PDCCH order indicating a retransmission state associated with a physical random access channel (PRACH) message that is associated with the candidate cell; and
transmit the PRACH message that is associated with the candidate cell based at least in part on the retransmission state.

2. The apparatus of claim 1, wherein the one or more processors, to cause the UE to receive the PDCCH order, are configured to cause the UE to:
receive the PDCCH order in downlink control information (DCI) that is based at least in part on a PDCCH order DCI format.

3. The apparatus of claim 1, wherein the PDCCH order includes a power control field that indicates a transmission power level associated with the PRACH message.

4. The apparatus of claim 3, wherein the one or more processors, to cause the UE to transmit the PRACH message, are configured to cause the UE to:
transmit the PRACH message based at least in part on using the transmission power level that is indicated by the power control field.

5. The apparatus of claim 4, wherein the one or more processors are further configured to cause the UE to:
increase, incrementally, a respective transmission power level of each subsequent PRACH retransmission based at least in part on the PDCCH order indicating an enabled retransmission state; and
transmit each subsequent PRACH retransmission using the respective transmission power level based at least in part on the PDCCH order indicating the enabled retransmission state.

6. The apparatus of claim 1, wherein the PDCCH order includes a retransmission count field that indicates, as the retransmission state, one of:
a disabled retransmission state based at least in part on being set to a first value, or
an enabled retransmission state based at least in part on being set to a second value.

7. The apparatus of claim 6, wherein the one or more processors are further configured to cause the UE to:
calculate a transmission power level that is increased from a prior transmission power level associated with a prior PRACH transmission based at least in part on the retransmission state being the enabled retransmission state,
wherein the one or more processors, to cause the UE to transmit the PRACH message, are configured to cause the UE to:
transmit the PRACH message based at least in part on using the transmission power level that is increased from the prior transmission power level.

8. The apparatus of claim 1, wherein the one or more processors, to cause the UE to transmit the PRACH message, are configured to cause the UE to:
transmit the PRACH message using an initial transmission power level based at least in part on the PDCCH order indicating a disabled retransmission state.

9. An apparatus for wireless communication at a network node, comprising:
one or more memories; and
one or more processors, coupled to the one or more memories, configured to cause the network node to:
transmit a physical downlink control channel (PDCCH) order associated with performing a random access channel (RACH) procedure that is associated with a candidate cell and is not associated with a configured random access response (RAR), the PDCCH order indicating a retransmission state associated with a physical random access channel (PRACH) message that is associated with the candidate cell.

10. The apparatus of claim 9, wherein the one or more processors, to cause the network node to transmit the PDCCH order, are configured to cause the network node to:
transmit the PDCCH order in downlink control information (DCI) and based at least in part on a PDCCH order DCI format.

11. The apparatus of claim 9, wherein the PDCCH order includes a power control field that indicates a transmission power level associated with the PRACH message.

12. The apparatus of claim 9, wherein the PDCCH order includes a retransmission count field that indicates, as the retransmission state, one of:
a disabled retransmission state based at least in part on being set to a first value, or
an enabled retransmission state based at least in part on being set to a second value.

13. A method of wireless communication performed by a user equipment (UE), comprising:
receiving a physical downlink control channel (PDCCH) order that indicates to perform a random access channel (RACH) procedure that is associated with a candidate cell and is not associated with a configured random access response (RAR), the PDCCH order indicating a retransmission state associated with a physical random access channel (PRACH) message that is associated with the candidate cell; and
transmitting the PRACH message that is associated with the candidate cell based at least in part on the retransmission state.

14. The method of claim 13, wherein receiving the PDCCH order comprises:
receiving the PDCCH order in downlink control information (DCI) that is based at least in part on a PDCCH order DCI format.

15. The method of claim 13, wherein the PDCCH order includes a power control field that indicates a transmission power level associated with the PRACH message.

16. The method of claim 15, wherein transmitting the PRACH message comprises:
transmitting the PRACH message based at least in part on using the transmission power level that is indicated by the power control field.

17. The method of claim 16, further comprising:
increasing, incrementally, a respective transmission power level of each subsequent PRACH retransmission based at least in part on the PDCCH order indicating an enabled retransmission state; and
transmitting each subsequent PRACH retransmission using the respective transmission power level based at least in part on the PDCCH order indicating the enabled retransmission state.

18. The method of claim 13, wherein the PDCCH order includes a retransmission count field that indicates, as the retransmission state, one of:
a disabled retransmission state based at least in part on being set to a first value, or
an enabled retransmission state based at least in part on being set to a second value.

19. The method of claim 18, further comprising:
calculating a transmission power level that is increased from a prior transmission power level associated with a prior PRACH transmission based at least in part on the retransmission state being the enabled retransmission state,
wherein transmitting the PRACH message comprises:
transmitting the PRACH message based at least in part on using the transmission power level that is increased from the prior transmission power level.

20. The method of claim 13, wherein transmitting the PRACH message further comprises:
transmitting the PRACH message using an initial transmission power level based at least in part on the PDCCH order indicating a disabled retransmission state.
